(19) United States
(12) Patent Application Publication
(10) Pub. No.: US 2017/0297640 A1
(43) Pub. Date: Oct. 19, 2017

(54) MOTORCYCLE KICKSTAND PAD

(71) Applicant: Jess T. Wiinamaki, Green Bay, WI (US)

(72) Inventor: Jess T. Wiinamaki, Green Bay, WI (US)

(21) Appl. No.: 15/483,054

(22) Filed: Apr. 10, 2017

Related U.S. Application Data
(60) Provisional application No. 62/323,037, filed on Apr. 15, 2016.

(51) Int. Cl. B62H 1/02

(52) U.S. Cl. CPC B62H 1/02; B62H 2700/00

(57) ABSTRACT

A kickstand pad is configured to provide a surface on the ground on which a kickstand of a motorcycle rests to increase the motorcycle's stability when the motorcycle is parked. The kickstand pad includes a support pad, a tether, and a hook or clip. The support pad increases the amount of level surface area on which a free end of the kickstand can rest to avoid the kickstand embedding or piercing itself into the ground or soft pavement when the motorcycle is parked, which can result in a dangerous and/or damaging fall of the motorcycle. The support pad includes notches or winding features that facilitate storage of the tether when the kickstand pad is not in use. The tether may also serve as a visual reminder to the motorcycle operator to pick up the kickstand pad before driving away.

### BACKGROUND OF THE INVENTION

The present invention is directed to a pad for a motorcycle kickstand.

### SUMMARY OF THE INVENTION

The present invention provides a kickstand pad that is configured to provide a surface on the ground on which a kickstand of a motorcycle rests to increase the motorcycle's stability when the motorcycle is parked. According to an aspect of the present invention, the kickstand pad includes a support pad, a tether, and a clip or hook. The support pad increases the amount of level surface area on which a free end of the kickstand can rest to avoid the kickstand embedding or piercing itself into the ground or soft pavement when the motorcycle is parked. The tether is attached to the pad at a lower end and loosely secured at an upper end to the motorcycle, such as at the handlebar and/or mirror. The tether may also serve as a visual reminder to the motorcycle operator to pick up the kickstand pad before driving away. The support pad includes a provision to facilitate winding and storing the tether around the pad.

Thus, the kickstand pad provides a more stable surface on the ground for supporting or resting the kickstand of a motorcycle, to increase the motorcycle's stability when the motorcycle is parked. The kickstand pad may further include a tether and clips to increase its ease of use, while the support pad is configured to be compact, durable, lightweight, and soft to reduce the risk of marring chrome and painted surfaces.

These and other objects, advantages, purposes and features of this invention will become apparent upon review of the following specification in conjunction with the drawings.

### BRIEF DESCRIPTION OF THE DRAWINGS

FIG. 1 is a perspective view of a kickstand pad with tether, in accordance with the present invention;

FIG. 2 is a top plan view of the kickstand pad of FIG. 1 with the tether stored around the pad;

FIG. 3 is a perspective view of a handlebar end of the tether of FIG. 1 shown secured to a motorcycle handlebar that is depicted in dashed lines;

FIG. 4 is a top view of the tether of FIG. 1 showing the support pad end of FIG. 1 and the handlebar end of FIG. 3;

FIG. 5 is a top view of the kickstand pad of FIG. 1 shown without the tether and with exemplary dimensions;

FIG. 6 is a side elevation of the kickstand pad of FIG. 5;

FIG. 7 is a perspective view of the kickstand pad of FIG. 5;

FIG. 8 is a top plan view of another kickstand pad with additional notches, in accordance with the present invention;

FIG. 9 is a top plan view of another kickstand pad with additional notches, in accordance with the present invention;

FIG. 10 is a top plan view of another kickstand pad with additional notches, in accordance with the present invention;

FIG. 11 is a top plan view of the kickstand pad of FIG. 9 with the tether stored around the pad; and

FIG. 12 is a top plan view of the kickstand pad of FIG. 10 with the tether stored around the pad.

### DESCRIPTION OF THE PREFERRED EMBODIMENTS

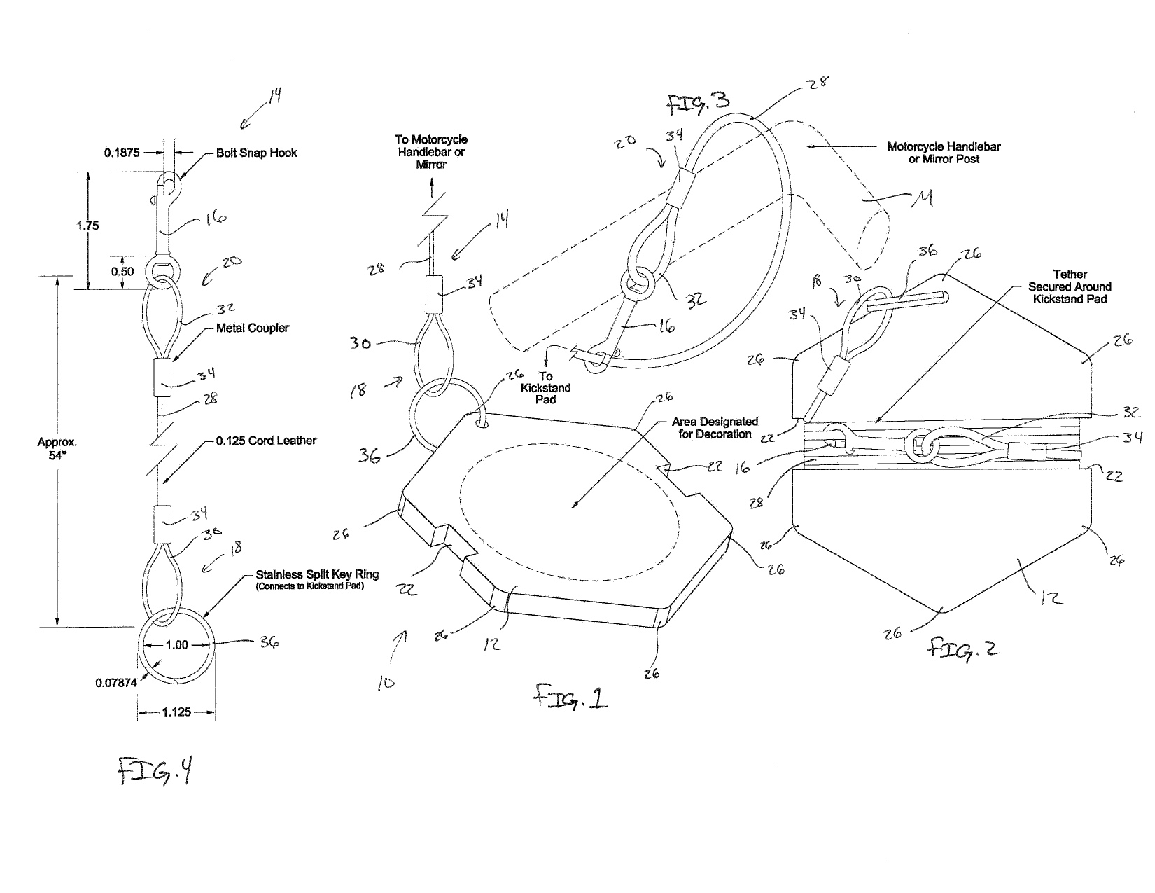

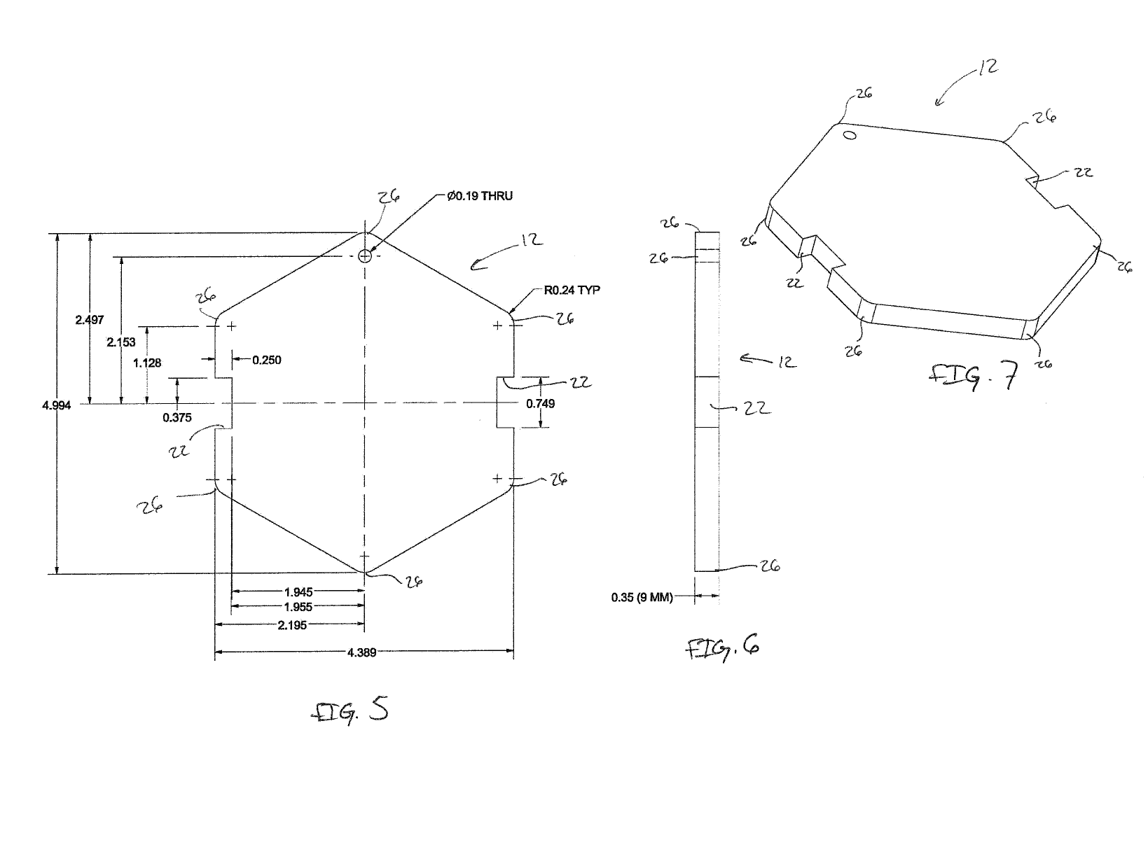

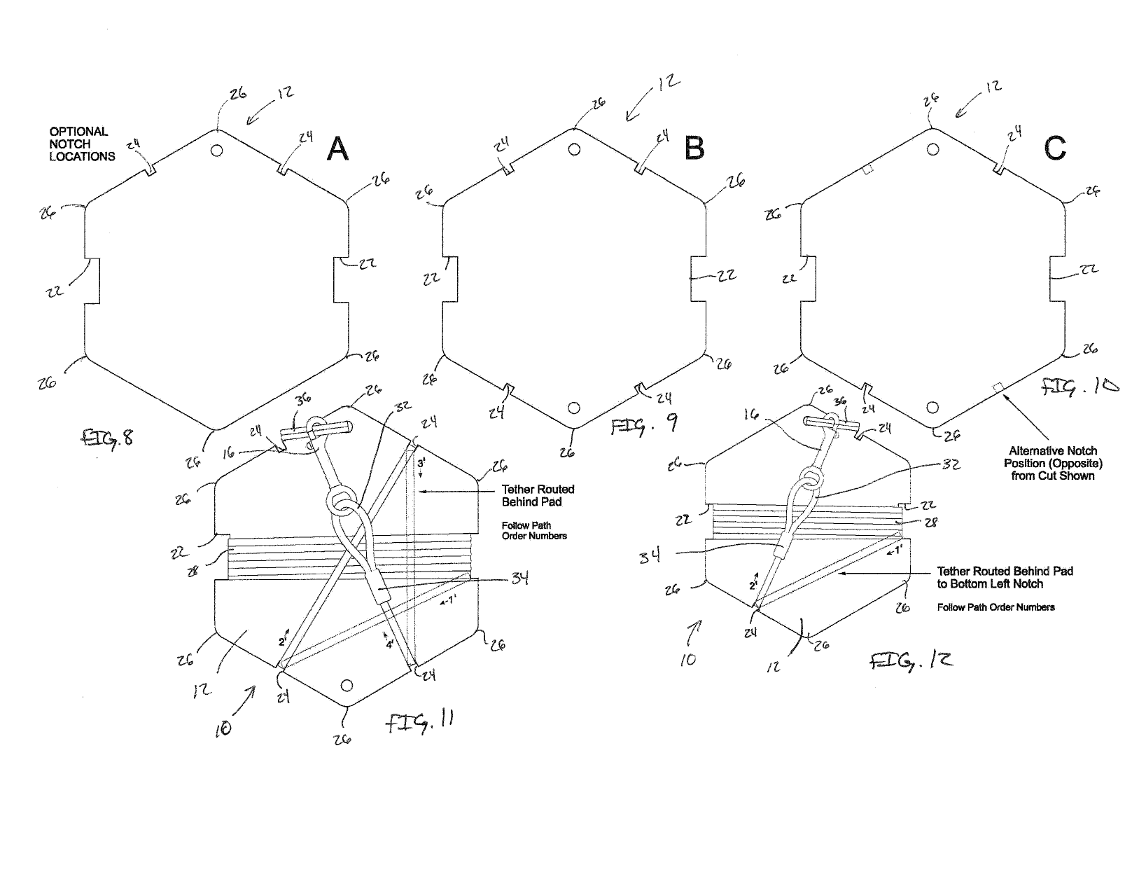

The present invention will now be described with reference to the accompanying figures, wherein the numbered elements in the following written description correspond to like-numbered elements in the figures. Referring to FIGS. 1-12, specifically to FIG. 1, a kickstand pad 10 is operable to provide a durable and substantially rigid surface on the ground on which a kickstand of a motorcycle rests to increase the motorcycle's stability when the motorcycle is parked. The kickstand pad 10 increases the amount of impenetrable surface area on which a free end of the kickstand can rest to avoid the kickstand embedding or piercing itself into the ground or soft pavement when the motorcycle is parked.

The kickstand pad 10 of the illustrated embodiment includes a support pad 12, a tether 14, and a hook 16. The tether 14 has lower end 18 attached to the support pad 12 (FIG. 1) and an upper end 20 that is loosely secured to the motorcycle near the handlebar and/or mirror M (FIG. 3). The tether 14 may serve as a visual reminder to the motorcycle operator to pick up the kickstand pad 10 before driving away. In addition, when the operator is ready to drive the parked motorcycle, the tether 14 assists the motorcycle operator by allowing the operator to retrieve the kickstand pad 10 when the operator is seated on the motorcycle, by grasping the tether 14 near the upper end 20. Thus, the tether 14 does not require the operator to bend over or get off of the motorcycle to retrieve the support pad 12, which may be potentially hazardous to the operator and the motorcycle, since many motorcycles are heavy (e.g. more than 800 lb), making them difficult to balance when stationary.

The tether also reduces the risk that misplacement of the pad on the ground or support surface will result in the user having to dismount and secure the motorcycle in order to retrieve a pad that has ended up in an undesirable location, since the tether can be used to retrieve the pad (or to help position the pad under the kickstand) without need for dismounting the motorcycle. In addition, it is envisioned that the non-circular perimeter shape, the energy-absorbing properties, and the weight of the support pad all will reduce the likelihood that the pad will inadvertently roll a significant distance away from the user in the event that it is dropped, and that it will not be very susceptible to being blown by wind, even if the tether is not used.

In the illustrated embodiment, the support pad 12 includes notches or recesses or voids 22 at opposing flat edges of the support pad 12 (see FIGS. 1, 2, and 5-11), on which to secure or coil the tether 14 around the support pad 12 when the kickstand pad 10 is not in use. In this embodiment, the tether 14 can be attached or unattached to the pad 12. Additionally, multiple additional notches 24 can be formed or established at the flat edges of the support pad 12 to provide more securing points for the tether 14, as described below.

Optionally, the support pad 12 includes notches 24 in multiple sides of the support pad 12 to position and secure the tether 14 when the kickstand pad 10 is not in use (see FIGS. 2, 11, and 12). The width and depth of the notches 24 (FIGS. 8-12) are designed to engage the tether 14 when the tether 14 is wrapped around the support pad 12. Thus, the notches typically have a depth that is equal to at least half the thickness of the tether, and which may be deeper and/or sufficiently wide to accommodate multiple winds of the tether in the same notch(es). The tether 14 can be wrapped around the pad 12 in various configurations and paths, but in the illustrated embodiment the tether 14 can be wrapped around the pad 12, via voids 22 and additional notches 24, in the path order 1′ to 2′ (FIGS. 12) and 1′ to 2′ to 3′ to 4′ (FIG. 11). The voids 22 and notches 24 allow the operator to store the pad 12 and tether 14 in a compact, wrapped configuration that reduces the risk of unwinding and/or entanglement.

It is envisioned that the support pads 12 of the illustrated embodiments may be made from recycled tire rubber that is granulated and bound by a urethane binder, and with sufficient density, to have characteristics that will support a portion of the motorcycle's weight. Thus, the pad 12 will have a desirable rigidity, pliability, coefficient of friction, degree of hardness, for a motorcycle weight, yet have a lightweight construction to be portable. The recycled tire rubber and urethane binder of the illustrated embodiment allow the pad 12 to better conform to uneven ground while also maintaining a large surface area for receiving the motorcycle kickstand. The low hardness of the rubber generally prevents the pad 12 from inadvertently scratching or scuffing chrome and paint of the motorcycle and kickstand. The rubber and urethane material also has a higher coefficient of friction, compared to metals and plastics, which restricts movement of the kickstand, particularly on hard and/or slippery surfaces, and is also corrosion and weather resistant. The lightweight construction provides ease of placement under the kickstand, portability, and ease of storage.

In the illustrated embodiments, the support pad 12 is formed as flat, generally hexagonal shape with rounded corners 26, such as shown in FIGS. 1, 2, and 5-12. The hexagonal-like shape facilitates multi-directional placement under a kickstand, unlike oval-like shapes or other directional-specific and asymmetric shapes that require specific placement or orientation to engage the kickstand and properly support the weight of the motorcycle. In addition, in the illustrated embodiments the support pads have substantially planar top and bottom surfaces, which facilitate their use in either orientation, and which also facilitates printing on the surfaces as desired. Thus, the support pads 12 of the illustrated embodiments can be positioned at various different orientations under the kickstand, and the kickstand can be readily centered on a given pad 12 without requiring mechanical adjustments.

The material used to form support pads 12 may begin in sheet form, and may be cut to the generally hexagonal pad shape using low-cost methods, including waterjet cutting tables, die cutting equipment, or the like, without requiring molds or machining. The sheet rubber can be cut or formed at specific thicknesses, and it is noted that the thickness of the pad 12 in the illustrated embodiment is between about 9 mm and 12 mm. Optionally, a reinforcement material, such as a fiber or metal wire weave may be incorporated into the support pad material to enhance its strength and durability.

The pad 12 can be used with many typical single-leg kickstand lengths and shapes because it is configured to be open and flat. Both top and bottom sides of the pad 12 are configured to be engaged by a kickstand. Each of the primary corners 26, for example the six primary corners 26 of the hexagonal-like shape of the illustrated embodiment, are rounded to reduce the likelihood of tearing and/or gouging of the rubber and leather cord. The round edges of the primary corners 26 also help to reduce “snagging” of the pad 12 with the tether 14 when placing the kickstand pad 10 in storage or removing from storage. The surface of the pad 12 is broad enough to support the kickstand, and may also be imprinted with advertising or customization, such as logos or designs. The inks used for logos or other images or printing are formulated for permanent chemical-bonding adhesion and wear resistance when applied to the rubber and urethane binder.

The tether 14 of the illustrated embodiment is manufactured from round leather cord 28 (FIGS. 1-4). A lower loop 30 is formed in the cord 28 at the lower end 18 and an upper loop 32 is formed in the cord 28 at the upper end 20, and each loop 30, 32 is secured by a metal coupler (cable crimp) 34 to secure the loops 30, 32 and help prevent unwinding. A connector such as a split key ring 36 is attached to the lower loop 18 that couples the lower loop 18 to the pad 12, and the hook or small bolt snap connector 16 is attached to the upper loop 20. The tether 14 may be formed of other materials, such as braided leather cord, nylon cord, metallic cord or the like (i.e. string or flexible wire).

The kickstand pad 10 is a compact and desirable accessory for storage either on the operator (i.e. jacket/accessory pocket) or in a motorcycle bag. For instances where a pocket or motorcycle bag(s) are not present, the tether 14 can be looped around the operator (such as the arm or torso) and the hook 16 secured to the split key ring 36. The operator can then wear the kickstand pad 10 across his/her body diagonally (similar to a single strap backpack) while riding.

Thus, the kickstand pad 10 provides a surface on the ground on which a kickstand of a motorcycle rests to increase the motorcycle's stability when the motorcycle is parked. The pad 12 increases the amount of surface area on which a free end of the kickstand can rest while preventing the kickstand from embedding itself or piercing into the ground or soft pavement when the motorcycle is parked, which can cause a parked motorcycle to fall over, and which can cause damage to the fallen motorcycle or other objects, and which can also present a safety risk. The kickstand pad includes a tether 14 and loops 30, 32 to increase its ease of use, yet is configured to be compact, durable, lightweight, and soft for non-marring use with chrome and painted surfaces.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. An apparatus for supporting a motorcycle on a ground surface, comprising:
a pad configured to engage a motorcycle kickstand and the ground surface; and
a tether coupled to said pad;
wherein said tether is positionable in a coupled position to couple to a portion of the motorcycle, and a stored position in which said tether is secured around said pad.

2. The apparatus of claim 1, said pad further comprising voids on opposing sides of said pad on which said tether secures to said pad by wrapping around said voids.

3. The apparatus of claim 2, said pad further comprising notches disposed on sides between said voids to engage said tether in said stored position.

4. The apparatus of any of the previous claims, said tether comprising a hook-like coupler at an upper end that is configured to couple said tether to an upper portion of the motorcycle.

5. The apparatus of any of the previous claims, said tether comprising a hook-like coupler at a lower end that is configured to couple said tether to said pad.

6. The apparatus of any of the previous claims, wherein said pad is substantially symmetric to engage a free end of the motorcycle kickstand in any orientation of said pad with respect to the motorcycle.

7. A kickstand pad for supporting a motorcycle on a ground surface, comprising:
a support pad configured to receive a motorcycle kickstand and to be supported at the ground surface;
wherein the support pad has a polygonal shape including at least two straight edges on opposite sides from one another, each of said at least two straight edges comprising a respective notch configured to receive a flexible elongate tether.

8. The kickstand pad of claim 7, further in combination with the flexible elongate tether.

9. The kickstand pad of claim 8, further comprising a first coupling element configured to couple said elongate tether to said support pad and a second coupling element configured to couple said elongate tether to the motorcycle.

10. The kickstand pad of claim 9, wherein said first and second coupling elements each comprise at least one chosen from a clasp, a hook, a split ring, a hook-and-loop fastener, and a loop formed in an end portion of said tether.

11. The kickstand pad of claim 7, wherein said support pad comprises a hexagonal shape.

12. The kickstand pad of any of claims 7-11, wherein said support pad comprises a planar top surface and a planar bottom surface opposite said top surface.

13. The kickstand pad of claim 12, wherein said top and bottom surfaces are parallel to one another.
